(19) United States
(12) Patent Application Publication
(10) Pub. No.: US 2025/0391058 A1
(43) Pub. Date: Dec. 25, 2025

(54) INTERPOLATED GEOMETRY IN DENSE GEOMETRY FORMAT ENCODING

(71) Applicant: Advanced Micro Devices, Inc., Santa Clara, CA (US)

(72) Inventors: Carsten Benthin, Munich (DE); David Kirk McAllister, Santa Clara, CA (US); Joshua David Barczak, Santa Clara, CA (US)

(73) Assignee: Advanced Micro Devices, Inc., Santa Clara, CA (US)

(21) Appl. No.: 18/752,129

(22) Filed: Jun. 24, 2024

(51) Int. Cl. G06T 9/00; G06T 15/06

(52) U.S. Cl. CPC G06T 9/001; G06T 15/06; G06T 2210/12; G06T 2210/21

(57) ABSTRACT

A geometry compression format is described. The compression format eliminates the need to store duplicate vertex information by storing unique vertices in each compressed data structure. Different triangles can refer to the same vertex using an index value, meaning that even if the same vertex is used multiple times in the compressed data structure, the entirety of the vertex information (e.g., positional information) does not need to be stored multiple times. An improvement can be made to the dense geometry format to support interpolation. More specifically, in an example, geometry for two different interpolation points can be provided in a compressed data structure encoded using the dense geometry format. Using an interpolation parameter, new interpolated geometry can be derived from the two different interpolation points. This interpolated geometry represents an intermediate point between the two interpolation points, where the similarity to either interpolation point is dependent on the interpolation parameter.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates dense geometry format, according to an example;

FIG. 6 describes the dense geometry format with interpolation points;

FIG. 7 illustrates a technique for generating interpolated geometry; and

FIG. 8 describes a method for performing compression and decompression operations for the dense geometry format with interpolated geometry.

### DETAILED DESCRIPTION

Dense geometry format is a compression format for geometry. The compression format stores geometry (e.g., primitives or triangles) in compressed data structures. The compression format eliminates the need to store duplicate vertex information by storing unique vertices in each compressed data structure. Triangles are represented in the format using topology information that includes, for example, a list of references (“indices”) to the unique vertices. Different triangles refer to the same vertex using an index. Thus, even if the same vertex is used in different triangles, the compressed data structure does not need to store all information (e.g., positional information) for each vertex multiple times. Instead, by storing indices for the triangles, duplicated inclusion of vertex data is eliminated, since an index consumes much less data than the full data for each vertex.

An improvement can be made to the dense geometry format to support interpolation. More specifically, in an example, geometry for two different interpolation points can be provided in a compressed data structure encoded using the dense geometry format. Using an interpolation parameter, new interpolated geometry can be derived from the two different interpolation points. This interpolated geometry represents an intermediate point between the two interpolation points, where the similarity to either interpolation point is dependent on the interpolation parameter.

A single compressed data structure that includes such interpolation points can reduce the space required for topology information, as the topology data already present can be shared between interpolation points. More specifically, because the interpolation points represent “the same” primitives, a single set of topology information can be used for both interpolation points. Any of a wide variety of techniques can utilize the interpolation, such as rasterization or ray tracing-based rendering, motion blurring, level-of-detail blending, or other techniques.

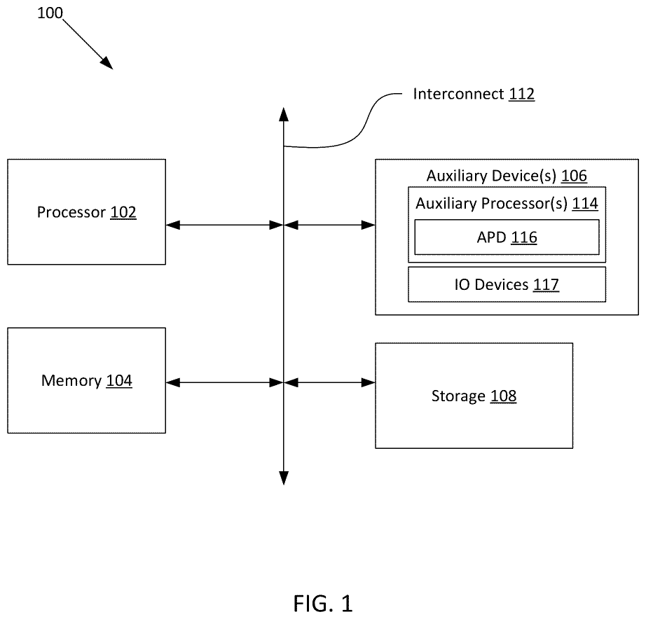

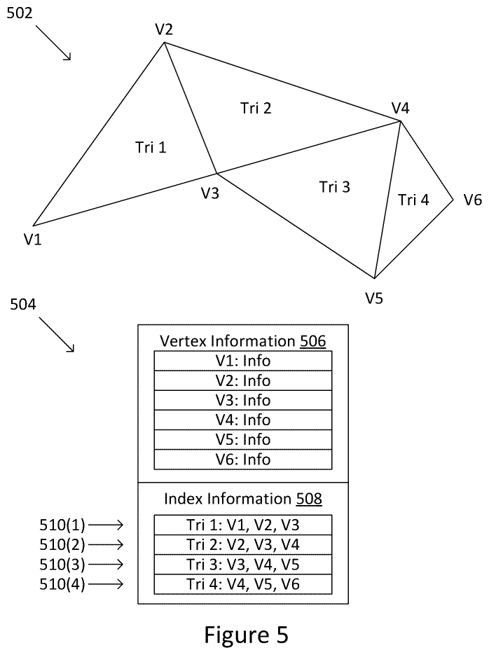

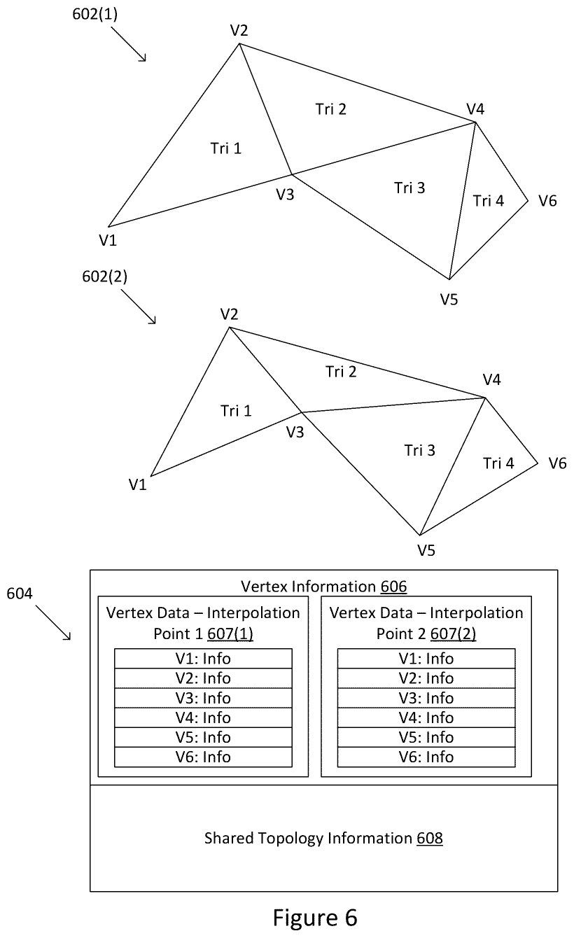

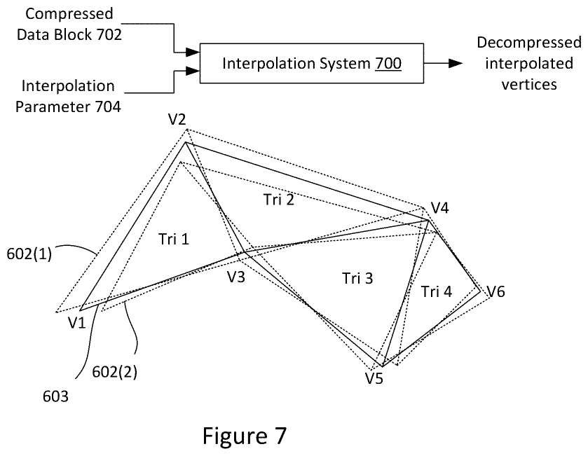

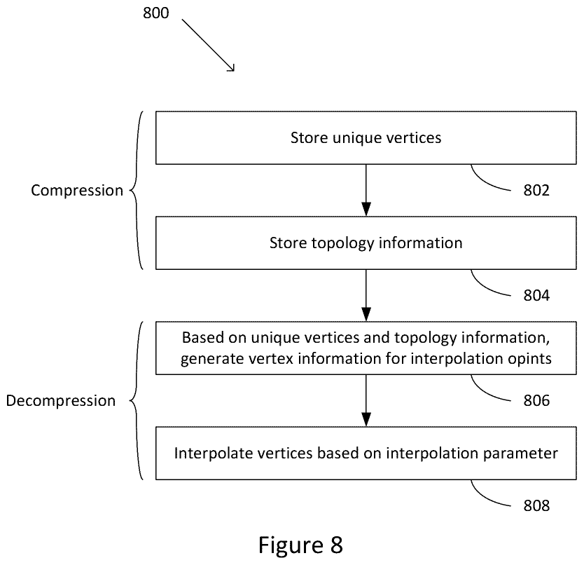

FIGS. 1-4 describe an example system in which the compression technique can be used. FIG. 5 describes the dense geometry format. FIG. 6 describes the dense geometry format with interpolation points. FIG. 7 illustrates a technique for generating interpolated geometry. FIG. 8 describes a method for performing compression and decompression operations for the dense geometry format with interpolated geometry.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

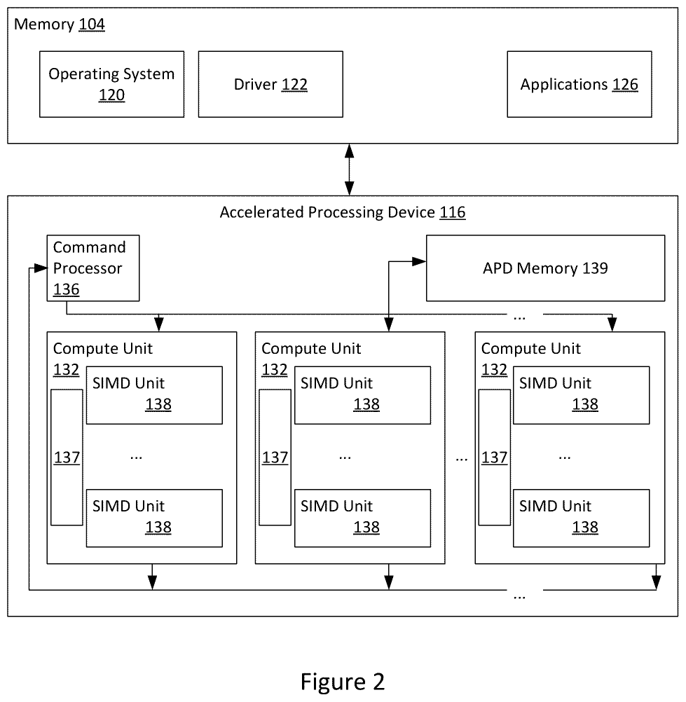

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (Al) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or Al operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

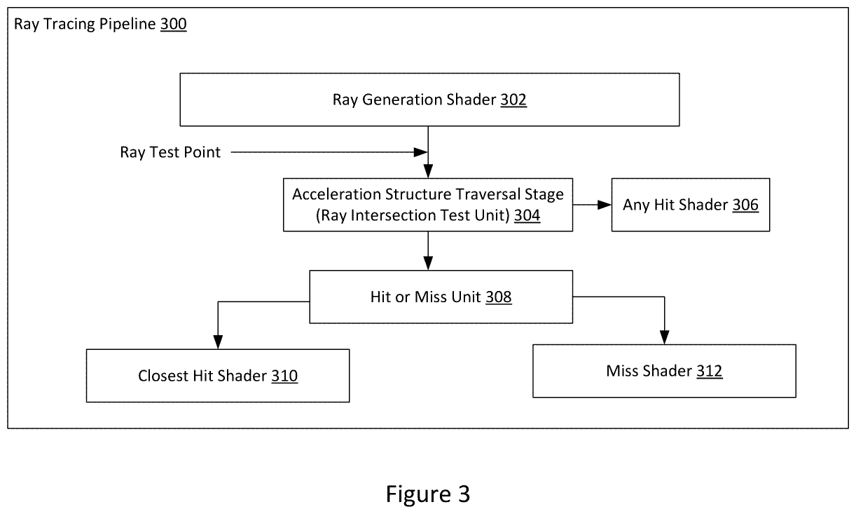

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

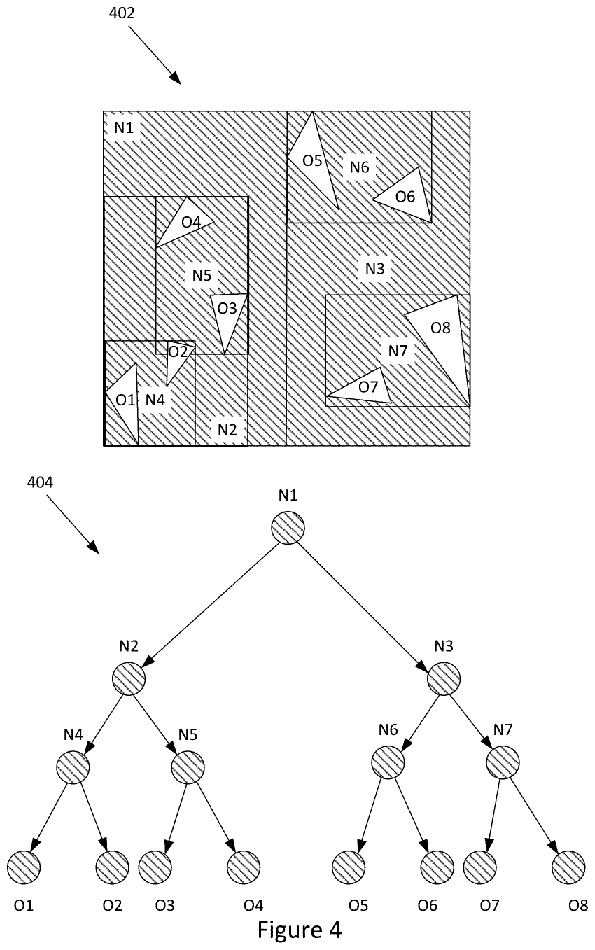

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

Geometry data of the leaf nodes can be compressed, which improves the memory or storage utilization and transfer bandwidth characteristics of the BVH. As described above, the leaf nodes of the BVH refer to primitives that can be rendered. It is possible that a leaf node refers to a compressed data structure that stores data for one or more primitives. More specifically, the compressed data structure includes information that specifies one or more triangles, and each leaf node of the BVH of FIG. 4 refers to one of the triangles in such a compressed data structure. To use such a compressed data structure, an device (e.g., device 100) compresses geometry into such compressed data structures. A BVH builder (e.g., software, hardware (such as circuitry), or a combination thereof) builds a BVH where the leaf nodes reference primitives in the compressed data structure. At render time, the ray tracing pipeline 400 arrives at a leaf node which specifies a triangle of a compressed data structure. The ray tracing pipeline 400 decompresses the compressed data structure to obtain an uncompressed primitive and performs operations for that primitive such as performing an intersection test or performing shading based on an intersected primitive. It should be understood that any particular compressed data structure can be referenced by one or multiple leaf nodes. Each leaf node would identify which primitive of the compressed data structure is associated with that leaf node and the decompression thus obtains the primitive data for that identified primitive when necessary.

FIG. 5 is a diagram illustrating aspects of a compressed data structure for storing primitive information, according to an example. FIG. 5 illustrates a set of triangles 502 and a compressed data structure 504 representing the set of triangles 502. The set of triangles 502 includes triangle 1, triangle 2, triangle 3, and triangle 4. Triangle 1 is composed of vertices V1, V2, and V3. Triangle 2 is composed of vertices V2, V3, and V4. Triangle 3 is composed of vertices V3, V4, and V5. Triangle 4 is composed of vertices V4, V5, and V6. In FIG. 5 (and elsewhere herein), triangles are labeled “tri X” (where X is a number).

The compressed data structure 504 includes information for these triangles. Specifically, the compressed data structure 504 includes vertex information 506 and index information 508. The vertex information 506 includes actual information about vertices, such as position information, material identifier, and geometry identifier. The index information 508, which is also sometimes referred to as “topology information” herein, indicates which vertices of the vertex information 506 make up the triangles represented by the compressed data structure 504. More specifically, the index information 508 includes triangle elements 510, each of which includes reference to vertices of the vertex information 506. In other words, each triangle element 510 includes a reference to a set of vertices, where that set of vertices together comprises a triangle.

In addition to the above, it is possible to represent all positional information for the vertices of the vertex information 506 in a fixed-point number space, rather than as floating-point numbers. The fixed-point number space is a “virtual grid” in which every increment of a number in the space has the same difference (rather than with floating point numbers, where the difference between adjacent representable values varies with the magnitude of the number). The fixed-point number space allows for a smaller number of bits to be used (e.g., 16 instead of 32) to represent the coordinate values for the vertices. In some examples, the vertex information 506 also includes a minimum and maximum value for all vertices in the vertex information 506, so that the fixed-point numbers, interpreted in light of these minimum and maximum values, are able to represent a large number of possible number within the range given by the minimum and maximum value.

As can be seen, the triangles in a compressed data structure 504 are represented in FIG. 5 with a set of vertex information 506 and a set of index information 508. The full set of information (e.g., parameters such as coordinates, material ID, or the like) for each vertex is included only once in each compressed data structure 504. For vertices used in multiple triangles, this information is effectively “de-duplicated” by referring to such vertices by reference in the triangle elements 510.

Although a set of explicit indices is shown, it is also possible to represent topology information with implicit indications of topology. In such examples, an implicit indication indicates the manner in which the vertex information 506 is combined to form triangles without using explicit indices for each vertices of such triangle. In an example, the implicit indication indicates a topology that indicates which triangles are formed by which vertices, based on the order of the vertices. In other words, instead of explicitly indicating exactly which vertices comprise which triangles, the implicit indication indicates a particular topology, which dictates how the order of the vertices determines which triangles are formed from such triangles. In an example, a topology indicates that the first three vertices (V0, V1, V2) form a triangle, and then a set of vertices shifted over by one (V1, V2, V3) form another triangle, and so on.

Although good compression characteristics are provided by the features described with respect to FIG. 5, FIG. 6 (and other subsequent figures) illustrates an additional technique whereby a compressed data structure 604 includes multiple sets of vertices, each of which represents an interpolation point for a set of geometry.

As shown in FIG. 6, such a compressed data structure 604 includes multiple sets of vertex data 607, as well as a set of shared topology information 608. Each set of vertex data 607 represents a particular interpolation point. An “interpolation point” is a set of data that can be used, along with another set of data, to perform interpolation to derive an interpolated value. In an example, a first interpolation point represents a first moment in time and a second interpolation point represents a second, subsequent moment in time. Interpolation between these interpolation points generates vertex information for a third, intermediate interpolation point based on the first interpolation point, the second interpolation point, and an interpolation coefficient that indicates the “distance” of the third interpolation point to the first interpolation point and the second interpolation point. This interpolation can be used for a variety of purposes, such as generating geometry for a variable intermediate time point between two time points for which data is explicitly stored, performing motion blurring, or performing any of a wide variety of techniques that use interpolation.

The shared topology information 608 includes topology information for both the interpolation point 1 607(1) and interpolation point 2 607(2). More specifically, both interpolation point 1 607(1) and interpolation point 2 607(2) are intended to represent the “same” set of geometry. In other words, despite the fact that interpolation point 1 607(1) and interpolation point 2 607(2) are permitted to specify different vertex attributes (e.g., different vertex positions), the vertices represented by each interpolation point are associated with the same triangles in a mesh. In other words, the triangles, defined by combinations of which sets of vertices in each respective interpolation point 607 comprises such triangles, is the same for each interpolation point 607. In an example, if vertices V1, V4, and V5 of interpolation point 1 607(1) form triangle 1 for interpolation point 1, then vertices V1, V4, and V5 of interpolation point 2 607(2) for triangle 1 for interpolation point 2. In some examples, for the term “VX” where “X” is a number, the number “X” refers to the order of the item of vertex data within the vertex data 607. Thus, vertex info V1 is in the same location (e.g., first) within the vertex data 607(1) as vertex info V1 in vertex data 607(2). Put differently, the fact that the shared topology information 608 is “shared” between the interpolation points means that the connectivity defined by the topology information 608 for the interpolation point 1 607(1) is the same as that for the interpolation point 2 607(2). The “connectivity” refers to how triangles are formed from the connections between the vertices.

In some examples, the shared topology information 608 is “shared” in the sense that this information specifies only one copy of such topology information, which is interpreted similarly for both the first interpolation point 607(1) and the second interpolation point 607(2). In other words, the shared topology information includes an indication of which vertices comprise which triangles only one time for each triangle. Since each such triangle exists in both the first interpolation point 607(1) and the second interpolation point 607(2), a second copy of the topology information for the triangles is not needed. In an example, there is only one copy of topology information that indicates that vertices V1, V3, and V4 comprise triangle 1, and this information is used for both the first interpolation point 607(1) and the second interpolation point 607(2).

In various examples, the first interpolation point 607(1) and the second interpolation point 607(2), have the same number of vertices. Thus, in some examples, the first interpolation point 607(1) and the second interpolation point 607(2), when interpolated in light of the shared topology information 608, represent the same number of triangles.

In the example of FIG. 6, a first set of primitives 602(1) corresponds to the first interpolation point 607(1) and a second set of primitives 602(2) corresponds to the second interpolation point 607(2). As can be seen, these two sets of primitives 602 include the same number of triangles composed of the “same” vertices, although the vertices in the different interpolation points can have different attributes such as positions.

In summary, the compressed data block 604 includes two sets of vertex data for different interpolation points 607, as well as shared topology information 608 that indicates how primitives are formed from the vertex data. This information can be used to generate a new, interpolated set of vertex information (and thus primitive information) using an interpolation parameter.

FIG. 7 illustrates an interpolation operation, according to an example. An interpolation system 700 receives a compressed data block 702 and an interpolation parameter 704. The interpolation system 700 is, in various examples, a processor such as the processor 102 or the APD 116. In some examples, the interpolation system 700 is part of the ray tracing pipeline 400, such as a hardware processor (e.g., circuitry) of the ray intersection test unit 304. In some examples, the interpolation system 700 is software executing on a processor such as the processor 102 or APD 116.

In some examples, the interpolation parameter is provided by software executing on the processor 102 and/or by software executing on the APD 116 (e.g., a shader). In some examples, the interpolation parameter is associated with a given ray, such that as the ray intersection pipeline 400 is evaluating the ray for intersection with the geometry of a BVH that references a compressed data structure 604, the ray intersection pipeline 400 applies that interpolation parameter to each compressed data structure 604 with multiple interpolation points that are encountered. In some examples, different compressed data structures 604 are associated with different interpolation parameters. In such examples, the entity that provides the interpolation parameter provides a list of interpolation parameters and associated compressed data structure 604 along with requesting drawing of the geometry represented by the BVH that has references to the compressed data structures 604.

The interpolation parameter defines the manner in which interpolated geometry is generated based on the different interpolation points 607 of a compressed data structure 604. In some examples, the interpolation parameter defines an intermediate state between the vertices of the different interpolation points 607. In an example, the interpolation parameter is a value between 0 and 1. In this example, 0 represents the first interpolation point 607(1) and 1 represents the second interpolation point 607(2). In this example, the difference between the value of the interpolation parameter and 0 or 1 represents how close the resulting interpolated vertex is to the first interpolation point 607(1) and the second interpolation point 607(2), with a value closer to 0 resulting in an interpolated vertex that is closer to the corresponding vertex of the first interpolation point 607(1) and a value closer to 1 resulting in an interpolated vertex that is closer to the corresponding vertex of the second interpolation point 607(2). In some examples, applying interpolation using the interpolation parameter, to obtain an interpolated vertex based on a corresponding vertex (e.g., V1) of the first and second interpolation points includes obtaining the coordinate difference between the first and second interpolation point, multiplying that difference by the interpolation parameter, and adding the multiplied difference to the vertex of either the first interpolation point or the second interpolation point. In various examples, the interpolation is applied separately to the different vertices of the interpolation points 607(1). For example, vertex V1 is interpolated to generate vertex V1 of interpolated geometry, vertex V2 is interpolated to generate vertex V2 of interpolated geometry, and so on.

As described, the geometry of the compressed data structure is compressed. Such compression includes use of the shared topology information 608 to de-duplicate vertex information in the vertex information 606, and can also include using a compressed numerical system (e.g., fixed-point). Thus, in some examples, the interpolation system 700 decompresses this information, by, for example, obtaining the appropriate vertex data for a given triangle, and then performs interpolation on this information. In some examples, obtaining the appropriate vertex data includes determining, based on the topology information 608, which vertex elements (e.g., V1 or V2, or V5 of the vertex information 606) comprise a given triangle, for each of the interpolation points 607 of the compressed data structure 604. Once this information is obtained, the interpolation system 700 interpolates this information based on the interpolation parameter.

A first set of geometry 602(1) represents the first interpolation point and the second set of geometry 602(2) represents the second interpolation point. The interpolated geometry 603 is shown in solid.

FIG. 8 is a flow diagram of a method 800 for processing a compressed data structure for storing geometry, according to an example. Although described with respect to the systems described herein, those of skill in the art will understand that any system configured to perform the steps of the method 800 in any technically feasible order falls within the scope of the present disclosure.

The method 800 includes steps (802, 804) that are labeled compression and steps (806, 808) that are labeled decompression. In various examples, each of the compression and the decompression are performed by one or more processors. More particular any such processor could be a programmable processor, fixed function processor, application-specific integrated circuit, fixed function analog circuit, a programmable logic device, field programmable gate array, or any other type of circuitry programmed or configured to perform the operations described herein. In some examples, the one or more processors that performs decompression is different than the one or more processors that performs compression. In other examples, one or more of the processors that perform decompression is different than one or more of the processors that perform compression. The term “compressor,” e.g., when used to refer to the entity that performs the compression operations, refers to the one or more processors that performs the compression operations and the term “decompressor,” e.g., when used to refer to the entity that performs the decompression operations, refers to the one or more processors that performs the decompression operations. In various examples, compression is performed by a processor such as a CPU (e.g., a processor 102), a GPU (e.g., an APD 116), or another processor. In various examples, decompression is performed by a processor such as a CPU (processor 102) or GPU (APD 116). In various examples a ray tracing pipeline 400, implemented on an APD 116, performs decompression in the course of obtaining primitives from a leaf node. In other words, in such examples, the ray tracing pipeline 400 obtains primitives from compressed data structures (as described elsewhere herein) upon arriving at a leaf node. In other examples, a rasterization based pipeline (e.g., a pipeline based on vertex shaders and pixel shaders) performs decompression on a compressed data structure storing primitives according to the techniques described herein, in order to process such primitives (e.g., in order to perform vertex shading with such primitives, and to otherwise process such primitives).

At step 802, a compressor stores unique vertices into a compressed data structure. As described herein, a compressed data structure stores unique vertices and topology information that indicates how the vertices are interpreted as primitives. Each unique vertex is stored only once for each interpolation point in the compressed data structure, as any duplicate use of a vertex is indicated (e.g., implicitly) by the topology information.

At step 804, the compressor stores topology information. The topology information indicates how primitives are formed from the unique vertices. The topology information can be implicit (e.g., indicating how to interpret the vertices as primitives) or explicit (e.g., indicating exactly which vertices comprise which triangles).

At step 806, a decompressor generates vertex information for primitives of the interpolation points based on the unique vertices, and the topology information. More specifically, to generate any given primitive, the decompressor selects a set of vertices from the unique vertices that correspond to that primitive, where the selection is performed based on the topology information.

At step 808, the decompressor performs interpolation, using the provided interpolation parameter and the obtained interpolation points, to generate interpolated geometry. Such interpolation generates vertex values that are between the corresponding vertices of the interpolation points, where the distance to each such interpolation point is based on the interpolation parameter, as described elsewhere herein (e.g., FIG. 7).

In various examples, the decompressor of FIG. 8 is the interpolation system 700 of FIG. 7.

As described elsewhere herein, the interpolated geometry can be used for a variety of purposes. In an example, such interpolation provides the ability to reuse geometry (e.g., interpolation point geometry) to produce a range of different interpolated values, which can improve performance by reducing the amount of geometry that needs to be processed (e.g., reducing the frequency at which a BVH must be built). In an example, two consecutive frames use the same compressed data structure simply by varying the interpolation parameter. More specifically, initially, an entity (e.g., the ray tracing pipeline) builds a BVH based on geometry that is represented at least partially by compressed data structures. Then, in a first frame, the entity (e.g., the ray tracing pipeline) renders the frame using geometry generated for a first interpolation parameter and in a second frame using geometry generated for a second interpolation parameter, using the same compressed data structures for the first and second frame, and without rebuilding the BVH.

In some examples, the interpolated geometry is used to render motion blur. More specifically, in such examples, a rendering entity extracts multiple interpolated items of geometry from a compressed data structure and blends these items of geometry together to generate a motion blur. The multiple interpolated items are extracted with different interpolation parameters, each representing a different point in a path of motion.

In some examples, the interpolated geometry is used to blend between multiple different geometry levels of detail. More specifically, in such an example, each interpolation point represents a different level of detail for the same geometry. A geometry level of detail reflects the number of primitives that represents the geometry, with a lower level of detail requiring fewer triangles. To provide a smooth transition between levels of detail, it is possible to interpolate between the levels of detail. Thus, in some examples, a system (e.g., a processor such as the processor 102 or APD 116) blends between the interpolation points of a compressed data structure based on an interpolation parameter that represents a level of detail in between those of the two interpolation points.

Although the term “triangle” or “quad” is sometimes used here, this term can be replaced with “primitive” for similar, though broader meaning. The term “primitive” refers generally to geometric objects such as triangle, quad, or other geometry object.

Any technically feasible system can request the decompressor to provide such decompressed triangles from a compressed data structure. In various examples, the ray tracing pipeline obtains such primitives upon arriving at a leaf node and performs intersection tests and other operations using such primitives. In other examples, a rasterization pipeline obtain triangles from a compressed data structure and performs rendering operations such as performing vertex shading, pixel shading, and outputting to a render target. Operations other than rendering using ray tracing or rasterization could be used as well. For example, modeling software could store geometry in a compressed format and compress and decompress such geometry for storage and display as needed. Any other software or hardware could perform operations using such compressed geometry.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138, local data store 137, APD memory 139, ray tracing pipeline 300, ray generation shader 302, acceleration structure traversal stage 304, any hit shader 306, hit or miss unit 308, closest hit shader 310, miss shader 312, or interpolation system 700, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
obtaining an interpolated primitive from a compressed data structure based on a first interpolation point of the compressed data structure, a second interpolation point of the compressed data structure, and an interpolation parameter, wherein the first interpolation point and the second interpolation point are defined with unique vertices and topology information; and
performing rendering operations utilizing the first primitive.

2. The method of claim 1, wherein the topology information indicates implicit or explicit connectivity information.

3. The method of claim 1, wherein the compressed data structure stores vertex data for unique vertices.

4. The method of claim 3, wherein the topology information identifies which unique vertices comprise which triangles.

5. The method of claim 1, wherein the first interpolation point and the second interpolation point represent different levels of detail of geometry.

6. The method of claim 1, wherein the interpolation parameter is provided on a per-ray basis or on a per-compressed-data-structure-basis.

7. The method of claim 1, wherein the rendering operations comprise one of performing rasterization-based rendering or performing ray tracing based rendering.

8. The method of claim 1, further comprising compressing a plurality of primitives including the first primitive to generate the compressed data structure.

9. The method of claim 8, wherein the compressing comprises storing unique vertices and the topology information into the compressed data structure.

10. The method of claim 1, wherein the obtaining comprises performing interpolation in one of a fixed-point number space or a floating-point number space.

11. The method of claim 1, wherein the compressed data structure includes three or more interpolation points.

12. The method of claim 1, wherein the obtaining comprises performing one of a linear interpolation or a non-linear interpolation.

13. A system comprising:
a memory configured to store a compressed data structure; and
a processor configured to:
obtain an interpolated primitive from a compressed data structure based on a first interpolation point of the compressed data structure, a second interpolation point of the compressed data structure, and an interpolation parameter, wherein the first interpolation point and the second interpolation point are defined with unique vertices and topology information; and
perform rendering operations utilizing the first primitive.

14. The system of claim 13, wherein the topology information indicates implicit or explicit connectivity information.

15. The system of claim 13, wherein the compressed data structure stores vertex data for unique vertices.

16. The system of claim 15, wherein the topology information identifies which unique vertices comprise which triangles.

17. The system of claim 13, wherein the first interpolation point and the second interpolation point represent different levels of detail of geometry.

18. The system of claim 13, wherein the interpolation parameter is provided on a per-ray basis or on a per-compressed-data-structure-basis.

19. The system of claim 13, wherein the rendering operations comprise one of performing rasterization-based rendering or performing ray tracing-based rendering.

20. A non-transitory computer-readable medium storing instructions that, when executed by a processor, cause the processor to perform operations comprising:
obtaining an interpolated primitive from a compressed data structure based on a first interpolation point of the compressed data structure, a second interpolation point of the compressed data structure, and an interpolation parameter, wherein the first interpolation point and the second interpolation point are defined with unique vertices and topology information; and
performing rendering operations utilizing the first primitive.
